(19) United States
(12) Patent Application Publication
(10) Pub. No.: US 2015/0134921 A1
(43) Pub. Date: May 14, 2015

(54) STORAGE UNIT AND CONTROL SYSTEM

(71) Applicant: Silicon Motion, Inc., Jhubei City (TW)

(72) Inventor: Jiyun-Wei LIN, Xinpu Township (TW)

(21) Appl. No.: 14/304,045

(22) Filed: Jun. 13, 2014

(30) Foreign Application Priority Data
Nov. 11, 2013 (TW) 102140823

(51) Int. Cl. G06F 3/06

(52) U.S. Cl. CPC G06F 3/0658; G06F 3/0604; G06F 3/0673; G06F 2003/0695
USPC 711/154

(57) ABSTRACT

A storage unit coupled to a controller for receiving a first control signal and a second control signal is provided. The storage unit includes a cell array, a first access module and a second access module. The cell array stores data. The first access module accesses the data stored in the cell array according to the first control signal. The second access module processes the data stored in the cell array according to the second control signal to generate a search result and provides the search result to the controller. When the first access module receives the first control signal and the second access module receives the second control signal, the first and second access modules simultaneously operate.

### CROSS REFERENCE TO RELATED APPLICATIONS

This Application claims priority of Taiwan Patent Application No. 102140823, filed on Nov. 11, 2013, the entirety of which is incorporated by reference herein.

### BACKGROUND OF THE INVENTION

1. Field of the Invention

The invention relates to a storage unit, and more particularly to a storage unit which is capable of providing specific data.

2. Description of the Related Art

Storage units are usually applied in electronic devices to store data. The storage units comprise volatile memories and non-volatile memories. The volatile memories comprise random access memories (RAMs), dynamic random access memories (DRAMs) and static random access memories (SRAMs). The non-volatile memories comprise read-only memories (ROMs), programmable read-only memories (PROMs), erasable programmable read-only memories (EPROMs), electrically erasable programmable read-only memories (EEPROMs), and flash memories.

Generally, when an external controller desires to retrieve specific data stored in a storage unit (e.g. maximum data), since the external controller does not know the address corresponding the specific data, the external controller cannot provide the address corresponding to the specific data. Since the storage unit does not know the address of the specific data, the storage unit sequentially outputs all data. The external controller receives all data to determine whether the data output from the storage unit is the specific data. Therefore, the external controller spends long time to find the specific data.

### BRIEF SUMMARY OF THE INVENTION

In accordance with an embodiment, a storage unit is coupled to a controller for receiving a first control signal and a second control signal and comprises a cell array, a first access module and a second access module. The cell array stores data. The first access module accesses the data stored in the cell array according to the first control signal. The second access module processes the data stored in the cell array according to the second control signal to generate a search result and provides the search result to the controller. When the first access module receives the first control signal and the second access module receives the second control signal, the first and second access modules simultaneously operate.

In accordance with another embodiment, a control system comprises a controller and a storage unit. The controller sends a first control signal and a second control signal. The storage unit receives the first and second control signals and comprises a cell array, a first access module and a second access module. The cell array stores data. The first access module accesses the data stored in the cell array according to the first control signal. The second access module processes the data stored in the cell array according to the second control signal to generate a search result and provides the search result to the controller. When the first access module receives the first control signal and the second access module receives the second control signal, the first and second access modules simultaneously operate.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIGS. 1A and 1B are schematic diagrams of exemplary embodiments of a control system, in accordance with some embodiments; and

FIG. 2 is a schematic diagram of an exemplary embodiment of a storage unit, in accordance with some embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

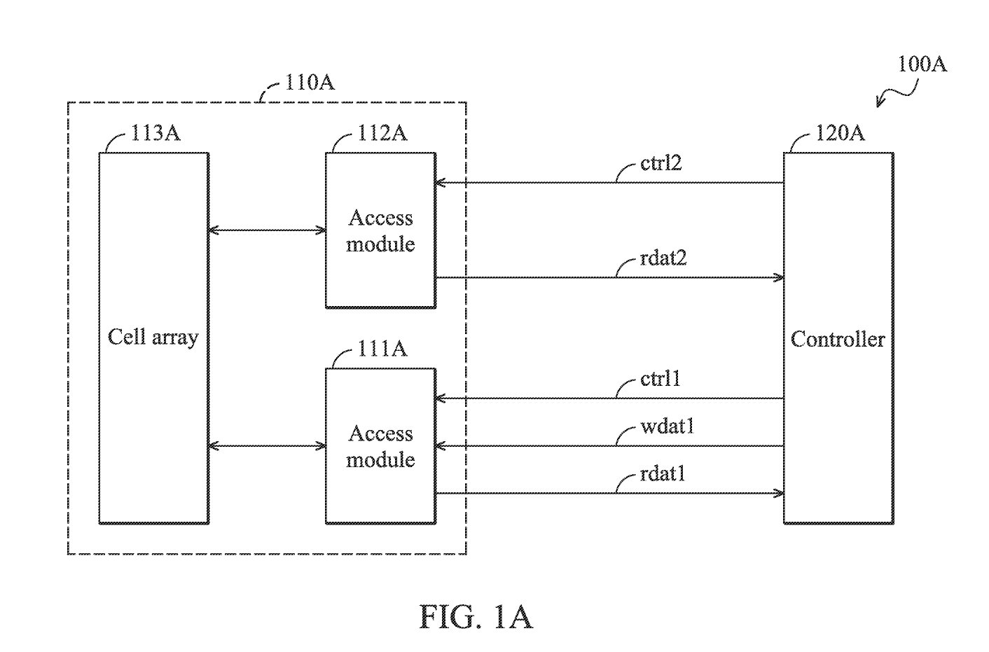

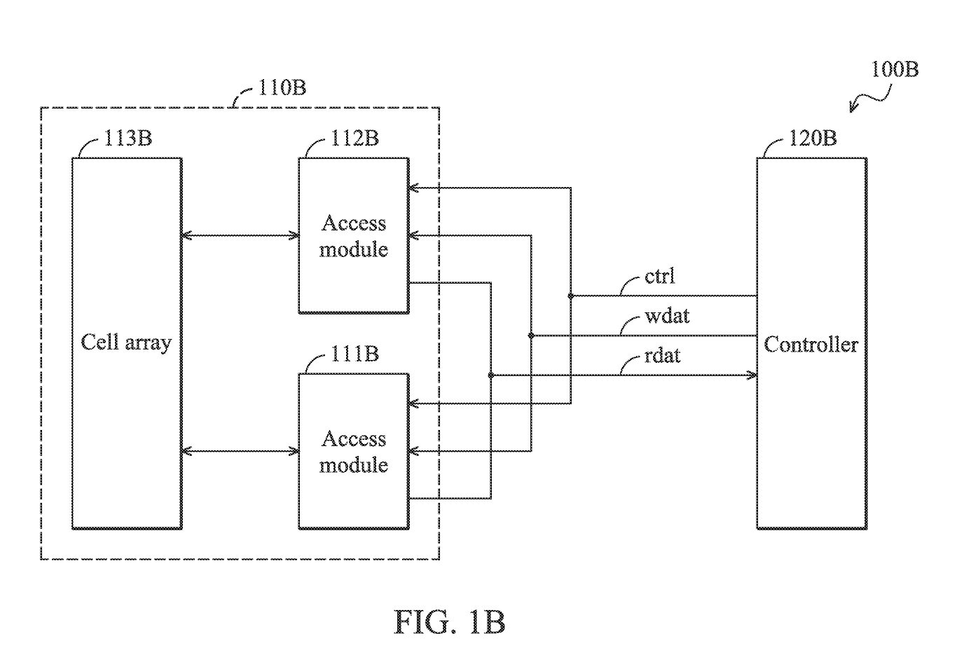

FIG. 1A is a schematic diagram of an exemplary embodiment of a control system, in accordance with some embodiments. The control system 100A comprises a storage unit 110A and a controller 120A. The controller 120A writes data into the storage unit 110A or reads the data stored in the storage unit 110A. In one embodiment, the controller 120A reads specific data stored in the storage unit 110A. For example, assume that the controller 120A desires to read maximum data stored in the storage unit 110A. In this case, the storage unit 110A processes the data stored in the storage unit 110A according to a setting condition (e.g. the control signal ctr12) provided by the controller 120A to search the maximum data stored in the storage unit 110A and then provides the search result (e.g. rdat2) to the controller 120A.

In other embodiments, the controller 120A utilizes another setting condition to retrieve minimum data stored in the storage unit 110A, an average or a distributed state of the values of the data stored in the storage unit 110A. In one embodiment, when the storage unit 110A provides specific data to the controller 120A, the storage unit 110A provides the specific data together with an address corresponding to the specific data to the controller 120A.

The invention does not limit the kind of storage unit 110A. In one embodiment, the storage unit 110A is a non-volatile memory, such as a static random access memory (SRAM). In other embodiments, the storage unit 110A is other types of non-volatile memory or volatile memory. In this embodiment, the storage unit 110A comprises access modules 111A, 112A and a cell array 113A.

The access module 111A accesses the data stored in the cell array 113A according to a control signal ctrl1. In one embodiment, the control signal ctrl1 comprises address information. The access module 111A accesses the cell array 113A according to the address information. The invention does not limit the circuit structure of the access module 111A. Any circuit can serve as the access module 111A, as long as the circuit is capable of accessing the cell array.

In one embodiment, access module 111A executes a write action or a read action for the cell array 113A according to the control signal ctrl1. When the access module 111A executes the write action for the cell array 113A, the access module 111A writes external data wdat1 into the cell array 113A. In one embodiment, the access module 111A encodes the external data wdat1 and then stores the encoded result in the cell array 113A. In another embodiment, when the access module 111A executes the read action, the access module 111A reads the data stored in the cell array 113A and outputs read data rdat1 to the controller 120A.

The access module 112A processes the data stored in the cell array 113A according to the control signal ctr12 to generate a search result rdat2 and provides the search result rdat2 to the controller 120A. In one embodiment, the control signal ctr12 may be the same as or different from the control signal ctrl1. In other embodiments, the control signal ctr12 is a setting condition. The access module 112A searches specific data stored in the cell array 113A or processes the data stored in the cell array 113A to obtain an average value or a data distributed state according to the control signal ctr12.

The invention does not limit the circuit structure of the access module 112A. In one embodiment, the access module 112A utilizes a digital method to read the data stored in the cell array 113A and executes a search comparing action to obtain specific data. In other embodiments, any circuit can serve as the access module 112A, as long as the circuit is capable of processing the data stored in the cell array 113A.

In one embodiment, the access module 112A executes a convergence algorithm to compare the data stored in the cell array 113A and then generates the search result rdat2 that indicates specific data, maximum data or minimum data. In another embodiment, the access module 112A processes the data stored in the cell array 113A to obtain an average value or data distributed information. In other embodiments, the search result rdat2 comprises specific data and an address corresponding to the specific data.

When the access module 111A executes a write action or a read action for the cell array 113A, if the access module 112A receives the control signal ctr12, the access module 112A can simultaneously execute a read action for the cell array 113A. Similarly, when the access module 112A executes a read action for the cell array 113A, if the access module 111A receives the control signal ctrl1, the access module 111A can simultaneously execute a write action or a read action for the cell array 113A. Therefore, the controller 120A not only obtains the data corresponding to a specific address, but also obtains specific information stored in the cell array 113A.

In one embodiment, during a first period, the controller 120A sends the control signal ctr12 to read the specific information stored in the storage unit 110A. During a second period, the controller 120A operates in a waiting mode. During this period, the controller 120A waits until the access module 112A generates a search result rdat2. The access module 112A processes the data stored in the cell array 113A according to the control signal ctr12 to generate the search result rdat2. During a third period, the controller 120A receives the search result rdat2.

In one embodiment, during the second period, the controller 120A sends the control signal ctrl1. When the control signal ctrl1 relates to a read action, the access module 111A reads the cell array 113A according to the control signal ctrl1 during at least one of the second and third periods. During at least one of the second and third periods, the access module 111A outputs a read result rdat1 to the controller 120A. When the control signal ctrl1 relates to a write action, the access module 111A writes the external data wdat1 into the cell array 113A according to the control signal ctrl1.

FIG. 1B is a schematic diagram of another exemplary embodiment of a control system, in accordance with some embodiments. In this embodiment, the access modules 111B and 112B encode the control signal ctrl to generate an encoded result and then access the cell array 113B according to the encoded result. In one embodiment, when the encoded result is a first state, it means that the controller 120B desires to write the external data wdat into the cell array 113B. Therefore, the access module 111B writes the external data wdat into the cell array 113B.

In another embodiment, when the encoded result is a second state, it means that the controller 120B desires to read data corresponding to a specific address within the cell array 113B. In this case, the access module 111B reads the cell array 113B according to the specific address and then provides the read data rdat to the controller 120B.

In other embodiments, when the encoded result is a third state, it means the controller 120B desires to read specific data stored in the cell array 113B. Therefore, the access module 112B searches or processes the data stored in the cell array 113B to generate a search result and serves the search result as the read data rdat to the controller 120B.

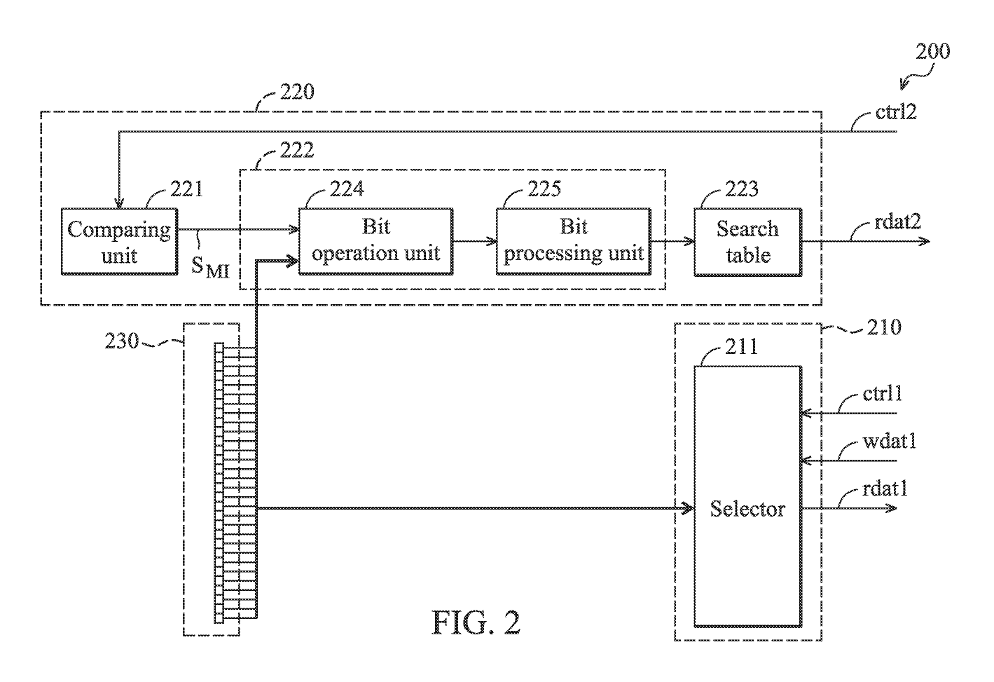

FIG. 2 is a schematic diagram of an exemplary embodiment of a storage unit, in accordance with some embodiments. The storage unit 200 comprises access modules 210, 220 and a cell array 230. The invention does not limit the circuit structure of the access module 210. In this embodiment, the access module 210 comprises a selector 211, such as a multiplexer. The selector 211 is coupled to each bit cell within the cell array 230. The selector 211 writes external data wdat1 into the cell array 230 according to the control signal ctrl1. In another embodiment, the selector 211 reads the data stored in each bit cell of the cell array 230 according to the control signal ctrl1 and outputs a read result rdat1.

In this embodiment, the access module 220 comprises a comparing unit 221, an operation unit 222 and a search table 223. The comparing unit 221 encodes the control signal ctr12 to generate compared information S_{M1}. The operation unit 222 is coupled to the cell array 230 to read the data stored in the cell array 230 and then processes the data stored in the cell array 230 according to the compared information S_{M1}. In one embodiment, the operation unit 222 comprises a plurality of comparators to compare the data stored in the cell array 230 with compared information S_{M1} to obtain specific data, maximum data or minimum data.

In this embodiment, the operation unit 222 comprises a bit operation unit 224 and a bit processing unit 225. The bit operation unit 224 processes the data stored in the cell array 230 according to the compared information S_{M1}. In one embodiment, the bit operation unit 224 executes a convergence algorithm for the data stored in the cell array 230. The bit processing unit 225 processes the operation results provided by the bit operation unit 224 to generate processed results and stores the processed results into the search table 223. In one embodiment, the search table 223 stores at least one of a data average value, a data distributed state, specific data, maximum data, and minimum data.

An external controller (e.g. 120A or 120B) quickly obtains the specific data according to information stored in the search table 223. Furthermore, the external controller provides a specific address such that the access module 210 reads the data stored in the cell array 230 or writes external data into the cell array 230 according to the specific address. Therefore, the storage unit 200 is capable of providing data corresponding to the specific address to the external controller and is capable of providing the specific data to the external controller according to a setting condition provided by the external controller.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A storage unit coupled to a controller for receiving a first control signal and a second control signal, comprising:
a cell array storing data;
a first access module accessing the data stored in the cell array according to the first control signal; and
a second access module processing the data stored in the cell array according to the second control signal to generate a search result and providing the search result to the controller, wherein when the first access module receives the first control signal and the second access module receives the second control signal, the first and second access modules simultaneously operate.

2. The storage unit as claimed in claim 1, wherein the first control signal equals the second control signal.

3. The storage unit as claimed in claim 1, wherein when the first and second access modules receive the first and second control signals respectively, the first access module receives external data according to the first control signal, encodes the external data to generate encoded data, and writes the encoded data into the cell array, and the second access module reads the cell array according to the second control signal.

4. The storage unit as claimed in claim 1, wherein when the first and second access modules receive the first and second control signals respectively, the first access module reads the cell array according to the first control signal, and the second access module reads the cell array according to the second control signal.

5. The storage unit as claimed in claim 1, wherein during a first period, the controller sends the second control signal, during a second period, the controller sends the first control signal after the second access module sends the search result, and during a third period, the controller receives the search result.

6. The storage unit as claimed in claim 5, wherein during at least one of the second and third periods, the first access module reads the cell array and sends a read result to the controller.

7. The storage unit as claimed in claim 5, wherein during at least one of the second and third periods, the controller provides external data, and the first access module writes the external data into the cell array according to the first control signal.

8. The storage unit as claimed in claim 1, wherein the second access module comprises an operation unit processing the data stored in the cell array according to a convergence algorithm.

9. The storage unit as claimed in claim 8, wherein the operation unit comprises a plurality of comparators for comparing the data stored in the cell array.

10. The storage unit as claimed in claim 1, wherein the search result comprises search data and an address corresponding to the search data within the data stored in the cell array.

11. A control system comprising:
a controller sending a first control signal and a second control signal; and
a storage unit receiving the first and second control signals and comprising:
a cell array storing data;
a first access module accessing the data stored in the cell array according to the first control signal; and
a second access module processing the data stored in the cell array according to the second control signal to generate a search result and providing the search result to the controller, wherein when the first and second access modules receive the first and second control signals respectively, the first and second access modules simultaneously operate.

12. The control system as claimed in claim 11, wherein the first control signal equals the second control signal.

13. The control system as claimed in claim 11, wherein when the first and second access modules receive the first and second control signals respectively, the first access module receives external data according to the first control signal, encodes the external data to generate encoded data, and writes the encoded data into the cell array, and the second access module reads the cell array according to the second control signal.

14. The control system as claimed in claim 11, wherein when the first and second access modules receive the first and second control signals respectively, the first access module reads the cell array according to the first control signal, and the second access module reads the cell array according to the second control signal.

15. The control system as claimed in claim 11, wherein during a first period, the controller sends the second control signal, during a second period, the controller sends the first control signal after the second access module sends the search result, and during a third period, the controller receives the search result.

16. The control system as claimed in claim 15, wherein during at least one of the second and third periods, the first access module reads the cell array and sends a read result to the controller.

17. The control system as claimed in claim 15, wherein during at least one of the second and third periods, the controller provides external data, and the first access module writes the external data into the cell array according to the first control signal.

18. The control system as claimed in claim 11, wherein the second access module comprises an operation unit processing the data stored in the cell array according to a convergence algorithm.

19. The control system as claimed in claim 18, wherein the operation unit comprises a plurality of comparators for comparing the data stored in the cell array.

20. The control system as claimed in claim 11, wherein the search result comprises search data and an address corresponding to the search data within the data stored in the cell array, and the storage unit is a SRAM.
